(19) United States
(12) Patent Application Publication
(10) Pub. No.: US 2013/0067405 A1
(43) Pub. Date: Mar. 14, 2013

(54) System and Method for Project Model Reuse

(71) Applicant: Uros Strel Lencic, Sentjernej (SI)

(72) Inventor: Uros Strel Lencic, Sentjernej (SI)

(73) Assignee: Ordo Group LLC, New York, NY (US)

(21) Appl. No.: 13/232,483

(22) Filed: Sep. 14, 2011

(51) Int. Cl. G06F 3/048

(52) U.S. Cl. 715/810

(57) ABSTRACT

A computerized system and method for management of one or more project models is presented. The system and method provides for a computer interface operating on a user's computer device having a processor and associated computer memory, a display and one or more input device. The computer device is in communication with the computer database, and the processor and memory are configured to provide various interfaces interface for the user to access and manage the project model libraries. The user may have a user account and one or more user profiles, and each user profile being associated with one or more project membership, as well as a single project model library.

### BACKGROUND OF THE INVENTION

1. Statement of the Technical Field

This invention generally relates to enabling efficient reuse of project information, and, more specifically, to a system and method for the creation, saving, reuse, liking, suggesting, following and improvement of project models, data, information, templates, metrics, patterns, tendencies, suggestions, or the like.

2. Description of the Related Art

In project planning, implementation and management, computerized/internet/web-based project tools are frequently used to create and manage activities, collaboration, information and other data and documents as project models, data, information, templates, metrics, patterns, tendencies, suggestions, etc., hereinafter collectively “project models”. Regardless of the type of project or work, process, or workflow they include, these project models can be created, liked, suggested, followed, saved, designed, reused, improved, and shared.

However, it is an enormous challenge to develop the methods, discipline and supporting systems which allow for easy reuse of project models for any individual, family, group, organization or company. For example, a given project may use several computerized, internet and mobile tools, each storing its data in various types of data files or database(s). A user wanting to reuse previously-developed project data is thus often faced with the daunting need to track numerous data, such as files, timelines, and correspondence in multiple formats.

This problem is compounded when a variety and mix of different work/project fields/industries or a set of organizations is desired.

Thus, there is a need for a system and method that offers comprehensive project workflow management support and establishes a solid foundation for improved efficiency and productivity.

There is also a need for a system and method that supports simultaneous group collaboration and enables saving the combinations of project elements/data as project models into a library or repository for repeated and shared use.

There is also a need for a project model library or repository having a modular structure. Small project modules or project elements may then be combined, like LEGO(™) bricks, to form bigger project models, which may then be further combined to form core project models for sharing among users. This is not only desirable to effectively maintain and organize project models, but would also be advantageous when these project models are brought into action, thereby fostering efficiency and productivity improvements.

### SUMMARY OF THE INVENTION

An aspect of the present invention provides a computerized/Internet or Web-based system and method for management of one or more project models. A computer interface operating on a user's computer or mobile device is provided, having a processor and associated memory, a display and one or more input device(s). This device is further in communication with one or more the server database, and the processor and memory are configured to provide the interface for the user to access and manage the server database(s).

In another aspect of the invention the user is provided with one user account and one or more user profiles, each user profile being associated with one or more project membership. Each user profile is also associated with a one project model library profile. All profiles, project memberships and library profiles are part of one user account and user can switch between them with no login/logoff procedure easy within the application. Two or more user profiles can share same profile data, such as name, surname, phone, email, website and other information.

In another aspect of the invention, the project model library is stored on a computer/server database, and contains one or more project models, including any project data files related to each project as well as any related project information. In typical usage, the user is presented with a listing of the one or more project models and the information related to each project model using the user's computing/Internet/mobile device, and may select a project model. Upon selection, the user is provided with the project model and all the associated data and information files on their computing/internet/mobile device.

In a further aspect of the invention, the user can access the project model data over the Internet.

In one aspect of the invention, the project model library is public, thereby allowing access to other users. In a further aspect of the invention access to the public project model library requires payment of a fee.

In another aspect of the invention, the project model library is private, thereby restricting access to the owner only.

In another aspect of the invention, the project model library is limited, allowing access to the owner and chosen users.

### BRIEF DESCRIPTION OF THE DRAWINGS

The novel features believed characteristic of the invention are set forth in the appended claims. The invention itself, however, as well as a best mode of use, further purposes and advantages thereof, will best be understood by reference to the following detailed description of an illustrative embodiment when read in conjunction with the accompanying drawings, where:

FIG. 1 is a schematic depiction of a system, in accordance with an embodiment of the invention.

FIG. 2(a) depicts a user account data structure, in accordance with an embodiment of the invention.

FIG. 2(b) depicts project membership, in accordance with an embodiment of the invention.

FIG. 2(c) depicts associated library profiles, in accordance with an embodiment of the invention.

FIG. 2(d) depicts a summary of the relationships between user accounts, user profiles, library profiles and project memberships, in accordance with an embodiment of the invention.

FIG. 3 is a flowchart depicting processes for the filtering of content and for applying content filters, in accordance with an embodiment of the invention.

FIG. 4 is a flowchart depicting a process followed when a user, through their library profile, selects a link to follow or unfollow some other library profile, in accordance with an embodiment of the invention.

FIG. 5 is a flowchart depicting actions taken when a user selects a link for reporting a project model, in accordance with an embodiment of the invention.

FIG. 6 is a flowchart depicting actions taken when a user through the user's selected library profile, selects a link to a project model the user “likes”, in accordance with an embodiment of the invention.

FIG. 7 is a flowchart depicting process flow when saving a project to a project model, in accordance with an embodiment of the invention.

FIG. 8(a) is a user interface screen, in accordance with an embodiment of the invention.

FIG. 8(b) is a user interface screen, in accordance with an embodiment of the invention.

FIG. 9 is a flowchart depicting process flow when editing an already existing project model, in accordance with an embodiment of the invention.

FIG. 10 is a user interface screen, in accordance with an embodiment of the invention.

FIG. 11 is a flowchart depicting process flow that occurs when a project model is saved from a public to a private library, in accordance with an embodiment of the invention.

FIG. 12 is a flowchart depicting process flow that occurs when a user selects to delete a project model from a project library, in accordance with an embodiment of the invention.

FIG. 13 is a flowchart depicting process flow that occurs when the user selects to create a new project from an existing project model, in accordance with an embodiment of the invention.

FIG. 14 is a user interface screen, in accordance with an embodiment of the invention.

FIG. 15 is a flowchart depicting processing available for managing the user's private library, in accordance with an embodiment of the invention.

FIG. 16(a) is a user interface screen, in accordance with an embodiment of the invention.

FIG. 16(b) is a user interface screen, in accordance with an embodiment of the invention.

FIG. 16(c) is a user interface screen, in accordance with an embodiment of the invention.

FIG. 17 is a flowchart depicting processing available for managing the public library, in accordance with an embodiment of the invention.

FIG. 18(a) is a user interface screen, in accordance with an embodiment of the invention.

FIG. 18(b) is a user interface screen, in accordance with an embodiment of the invention.

FIG. 18(c) is a user interface screen, in accordance with an embodiment of the invention.

FIG. 18(d) is a user interface screen, in accordance with an embodiment of the invention.

### DETAILED DESCRIPTION OF THE INVENTION

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

As mentioned above, “project models” as used herein generally relates to the models, data, information, templates, metrics, patterns, tendencies, suggestions and other project data, without limitation, created or modified for one or more project. When describing a project model library as herein, a variety of terms may be used interchangeably to refer to a project model, such as, but not limited to, “project model”, “project template”, “project formula”, “project metric”, “project data”, “project list”, “project documentation”, “project pattern”, “project tendency”, or “project suggestion”.

The present invention advantageously provides a system and method of that offers comprehensive project workflow management support and establishes a solid foundation for improved efficiency and productivity.

The present invention also advantageously provides a system and method that supports simultaneous group collaboration and enables saving the combinations of project elements/information/data as models into a library/repository for repeated and shared use.

The present invention also advantageously provides for library/repository structured modularly. Small bricks or project elements may advantageously be combined to bigger models that may then be further combined to form core models for sharing among users. This is advantageous when these models are brought into action, thereby fostering concrete, significant, constant and increased productivity, efficiency and other improvements.

The various systems and methods described herein are implemented using one or more computer processor and associated computer memory specially configured to perform the described functionality. In particular, the present invention finds advantageous usage in a multi-processing or multi-tasking environment. Persons of skill in the computer arts understand that various alternative processors using various operating systems and memory configurations may be used to implement the systems and methods described.

It is also envisioned that the systems and methods herein described may be provided for distribution on non-transient computer-readable media.

Various advantages are provided by the present invention. Regardless of the type of project workflow, it is possible to design project models with orderly arranged project elements, e.g., milestones, task lists, tasks, discussions, time, money, members, etc., using past project experiences and/or applying project management theory. These project models can be continuously improved through time, e.g., with new experiences and/or new project management theories. This can be accomplished by using a coherent system and enabling project collaboration management and allowing project models to be designed, reused and shared—thus creating a project model library for private, limited and public reuse and sharing.

It is useful to take into the account different project elements, suggestions, improvements, aspects, views, roles, problems and changes that arise during a project workflow, and to incorporate these into a project model. This demands ongoing cooperation among all subjects involved in the project, and is aided by the use of a coherent system which supports increased project productivity and efficiency improvements.

Project models designed in the manner described herein make it possible to deliver qualitatively enhanced project results. Even more, use of these project models stimulate the formation of new ideas.

Over the course of time, the project models may then evolve as a result of the practical experiences of project owners, managers, or even entire project teams and groups. Besides the condensed description of key and complimentary stages that the project models can deliver, they also deliver the ability to create innovative project solutions, and it is possible to exceed clients expectations and increase productivity and efficiency, which is the ultimate measure of project success.

It is a challenge to develop the method, the discipline and the supporting system that would easily enable designing, reusing and sharing of project models for any individual, family, group, organization or company. Trying to achieve these goals across a mix of different fields represents even bigger challenges.

When talking about projects, project processes are important considerations. Projects and project processes are strongly connected. Project processes may also be understood as phrases that define project concepts or “main ideas”, applied to the new projects. One can also use project processes as a communicational tool during the project workflow, in discussion with the project client, team and wider public.

From this, it also follows that anyone dealing with projects need to understand the importance of having the knowledge for designing, reusing and sharing project models, as well as needing to understand and be familiar with the project's structure and elements, which are all connected. They should be properly addressed and organized.

It is also very important that during the project workflow each project member has in mind not only an overview of the current state of the project, which is obvious, but also the passed achievements and possibly suggestions on how they can be improved. Such improvement suggestions may then be included in the next similar project.

An embodiment of the present invention provides for the use of a single system that offers comprehensive project workflow improvement support and establishes a solid foundation for improved efficiency and productivity. The system supports simultaneous group collaboration and enables saving combinations of project elements as one or more project model(s) into the project model library for repeated and shared use. This is necessary not only to effectively maintain and organize project models, but is also advantageous when project models are used, allowing for increased project productivity, creativity and efficiency improvements.

Increasingly, individual, family, group, organization and company projects are developed and managed using online collaboration technology. Use of online collaboration technology offers numerous solutions from to choose. It is important to choose coherent solutions which will at the same time enable efficient project management support and improvement of the doing.

A scattered project management system, however, is not advantageous. Most project activities that take place exclusively using such a scattered system, which does not contribute to an improved method of project workflow. In an embodiment of the invention, an online project model management application is provided.

The most common scattered project management system is one formed by using different online applications—document application, task application, money application, etc.—each of which are perfect for managing only certain project elements. Usually, all applications are connected by e-mail as the main tool for project communication. Working with scattered project management tools eventually becomes frustrating for the entire team because it is very stressful to find the right project information or a particular element among several scattered applications, because they are not synchronized. Also, it is practically impossible to save project elements into coherent project models because project elements can not be appropriately linked.

One of the most time consuming and annoying consequences of using a scattered system is the need for a different user account for each part of the given scattered system—e.g., for mail, for time logging, task logging, etc.—which often requires one to have to log in to each part of the system separately. Furthermore people typically collaborate on more than one project at the same time, frequently with different profiles—e.g., using different mails or contact data. For example one can be part of business process in company and also take part in organizing a family reunion. There is a simple way of attacking the multiple login (i.e. multiple user) problem with some applications which remember login data or even automatically do complete login procedure, but by doing so we also increase the scatteredness of system, and when different profiles are used, the scattered system may become totally unusable. For example, one would have to create an account for each profile—e.g., software engineer, mom, etc.—and suddenly one has many accounts in many applications, not interconnected, which soon becomes unmanageable.

Therefore, a scattered system does not sufficiently provide for improving the project workflow, because it is difficult to save different project elements in the appropriate form across such a system. In order for these elements to be useful, they need to be immediately available for reuse the next time a similar project occurs.

An embodiment of the present invention uses a single online collaboration and improvement application instead of a scattered system of individual online applications. It is better to use a single online application that supports project collaboration, productivity and creativity improvement, even if it cannot perfectly support all aspects of the project, as certain applications can. It is more important to improvement overall project support. For example, scattered systems tend to deal with each project element separately, whereas a single online collaboration and improvement application respects the differences among project elements/information and allows them to be logically connected and saved. This has a positive effect in terms of project productivity, efficiency and creativity improvement.

An embodiment of the present invention uses logic where people are not known by their accounts, as is web practice now, but instead are known by their profiles. A user has only one main account for login and billing, but may have multiple profiles. These profiles can have independent contact data, so one can have many profiles with one mail and other contact data), many profiles with many different mails, or any combination thereof.

Also in an embodiment of the invention, collaboration on projects is done via project memberships. Each membership is connected to one profile, which means that one can even collaborate on the same project with different profiles. It also means that for each project one chooses a profile for collaboration. Because this is all done under one user account, one can simply—literally with one click—switch between profiles and memberships, viewing only data relevant to a selected profile. The same holds for switching between different memberships on one project. No additional procedure, e.g., logoff/login, alias setting etc., is needed at all.

In an embodiment of the invention, the method of project workflow improvement focuses on the continued creation and storage of organized project elements into a personal or public project model library with various types of project models. It also provides for a cycle of constant exchange of the project model and project itself with its elements/information. The process of converting the project model into the project is carried out at project implementation/creation. For this it is always necessary to consider the various project roles, perspectives, issues, documents, changes and other elements that arise during the project workflow. It is preferable that these project element details are outside the one's mind so that the one can focus and concentrate only on project issues, such as performance, efficiency and improvement.

In an embodiment of the invention, each time a project model is used, the project workflow team constantly monitors changes, and applies appropriate improvements to the project model. It is also important that, at the completion of the project, a review and examination of the entire project takes place, with any necessary corrections made to the saved project model. Project teams and especially the project manager should always review, learn, improve and save the experience and knowledge gained as improved versions of project model. It is therefore useful for not only the project manager, but for the entire project team to apply their capability to together improve the project model.

Improved intercommunication between the project members in this matter is also an important feature of the invention. Project members are able to use prior project models and to generate changes and create new projects. This iterative design and improvement process may be used repeatedly, thereby allowing creation of improved projects over time, with no limitation.

In an embodiment of the invention, improved methods of project workflow require the use of comprehensive systems, as opposed to scattered systems which are poison to project productivity, efficiency and creativity. The coherent project- and process-oriented online collaboration and improvement application allows users to save all or only selected project elements as project models into the project model library, which can be immediately used by themselves or others for the creation of similar projects. In addition, the application can completely substitute any scattered system for the project work. With the help of the coherent online application that supports collaboration and improvement, it is possible to continuously improve project collaboration, innovation, competitiveness, productivity, efficiency and creativity on the level of any individual, family, group, organization and company, including on different profile levels.

An exemplary embodiment of the present invention calls for the use of a single system that offers comprehensive project workflow improvement support and establishes a solid foundation for the improved efficiency. The single system should support simultaneous group collaboration enabling saving the combinations of project elements as a project model into the library for repeated and shared use. This is not only preferable for effectively maintaining and organizing project models, but also advantageous when these project models are brought into action, by providing for constant and increased project productivity improvements.

The benefits offered by use of a single system which allows for continuous improvement to project models are useful to anyone dealing with repetitive project workflow who understands the importance of long-term performance, quality, efficiency, creativity and productivity improvement and increase. Applying project models into every day project work, improved creative potential can be unleashed. It can also help in creation of the environment that enables and stimulates continuous creative and productive work.

Today, almost every industry is already saturated with a many project groups in various organizations among whom though competition for potential clients ensues. Therefore, it is very important for every project individual, family, group, organization and company to design and constantly improve its own project models, which enables a more rapid launch of new projects, successful closure of the active projects and allows constant delivery of qualitative results and promises.

In an embodiment of the invention, a project model library serves as a tool for storing project elements as project models. A project model library stores project models in private and shared database libraries. Project team members may access their private libraries as well as models in others shared private libraries and public libraries according to permissions set up for each library. The general public can access all project models saved as public project models.

Each user's profile may be associated with one library profile, but data such as name, contact data, etc. are completely independent. Project models are published and owned by library profiles. If one has many library profiles—e.g., one for each profile—one can also switch between them in same way as switching between profiles.

Project models can be reused by anyone who has access to them via the library. Public project models are owned by project modelers who decide which project elements will be made available in the project model. Users of public project models have access to all project elements saved in project model and can use them for their projects. Users can also save public project models into their private project model libraries so they can access them faster when needed.

A project model may also be made available to one or more users for payment of a fee. In such an embodiment, a user would be charged a fee when accessing a project model to create a new project from the model.

Users can also save project model from the public library into it's own private library. User can change project model data. If user makes this project model publicly available than this action will be viewed as “roots” and “inspirations” in the project model library.

Projects may be created from an existing model in the library and then saved as new model in the library. In this case, the new model can be said to be “inspired” by existing model. “Roots” of selected model represent all previous models saved by another. The owner of a project model can also improve their project model by saving it as a new version. Project models can be organized by various parameters, such as, but not limited to: like topics, popularity, likes, followings—e.g., geographic specifications, owner or contributor, suggestions, by the number of projects created from the single project model, etc., without limitation.

Structured project models contain all or only selected project elements which are connected so they create a solid project model which can be used over and over again. A project model library may use topics to categorize project models which indicate the specific content and theme of the project models. Also, a project model may be simultaneously contained in several topics.

Some of the project models can only be accessed and used by their creators/owners. For example, this may apply to private project models which are saved in their private libraries. Creators/owners can give limited access/limited permission to their private libraries to selected users/members. Therefore, only selected users/members can use project models within private libraries to create new projects. Project model creators/owners can also choose which project models can be accessed by wider public audience beyond the owners/creators team/members/connections. This are public project models which anyone can use to create new project.

Anyone who decides to choose the project model for the production of their own project can create a new project and obtain the entire project and all associated project elements/information/data that are stored in the model which are necessary for the effective implementation of the project. The user of a project model can once again save project after completion into the library as their version of the starting project model. Doing so allows the user to add new experience through the new version of the project model. This strengthens the base of many project models that are based on user generation where new experiences and knowledge are constantly generated and available for further reuse. Through time, more perfected project models can be designed for the different types of projects. These project models can form a production base that can assist anyone using them and provide material for future work.

One idea behind project model library is that the project models can also be used by others who apply models to their own project models and mix them in a different way for similar projects, and publish them again for someone else to use. This may lead to globally open initiative project improvement method of core project processes which any individual, family, organization or company can potentially use as the latest and improved version of the project model for applying them on any type of project. It allows the complete disclosure of the project model which also exposes the mistakes which can be collaboratively removed.

Potentially, from a single project model hundreds of projects models and thousands of projects can be designed and implemented, which may continuously be reused by anyone. An important feature of the present invention is the facilitation of continuous improvement to project models, and emphasizing the importance of integrating improvements during the project workflow, especially at the very end of the project, when there is usually not enough time to deal with details of project saving and classification, because the project may already be behind schedule or the project team may be switched to another project. By building the project model library and constantly improving project models, the project group will always be closer to expedient completion and ahead of the competition, which increases the likelihood of success in the long term.

In addition, the project model library can also help with project improvement in the matter of quality, innovation and efficiency, because it enhances the ability to have accurate insight into the project operations. From one project model, multiple improved projects can be launched. For any individual, group, family, organization, or company, their own project model library represents the valuable collection of intellectual property and a measurement of continuous improvement and success.

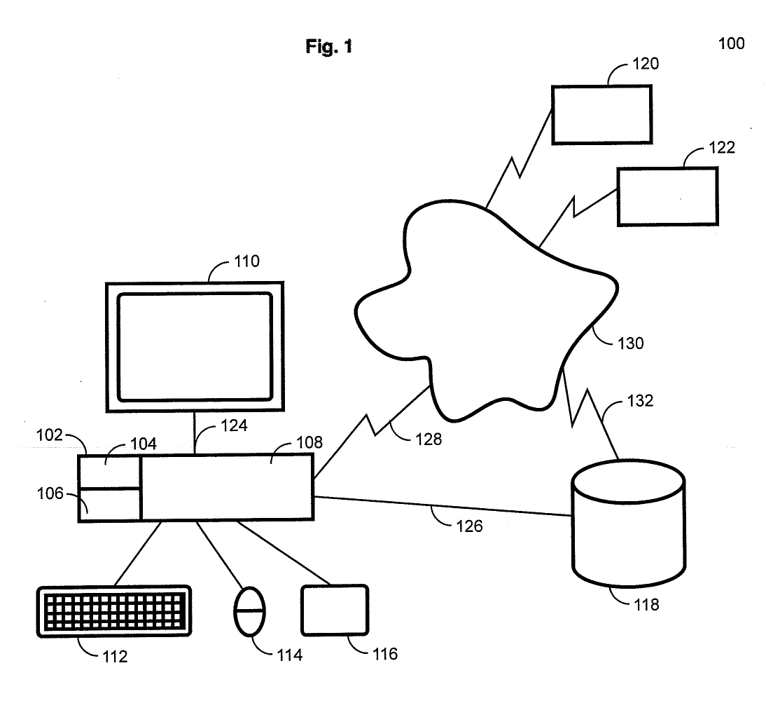

FIG. 1 is a schematic depiction of an exemplary inventive system. In an embodiment of the present invention, a user (not depicted) controls a computer workstation 102, which, at a minimum, includes a processor 104, associated electronic memory 106, other interconnected and related electronics 108—e.g., power supply, communication interfaces, input/output devices, etc. The workstation also controls a display 110 via a display interface 124. The user inputs control information to the workstation 102 by any of a keyboard 112, mouse 114, stylus pad 116, or any other known user interface or peripheral device in communication with the workstation 102, without limitation.

In various embodiments, the workstation 102 processor 104 may a single- or multi-processor or processor array, and may be configured together with the memory to operate any operating system or environment and application program(s) facilitating the project design and/or management, without limitation. Examples of usable workstations include, but are not limited to: personal computer, touch device, mobile device, virtual device, online systems, tablets, smartphones, netbooks, notebooks and other computerized systems. Examples of usable operating systems include but are not limited to: Windows, Mac OS, Linux, Android, iOS, WebOS, Symbian, Maemo, MeeGo, and the like. Examples of usable application programs include, but are not limited to:
raster applications, e.g., Adobe Photoshop, Gimp, Corel Paint Shop Pro, iPhoto, etc.;
vector applications, e.g., Adobe Illustrator, Corel Draw, Inkscape, etc.;
office applications, e.g., Microsoft Office, Libre Office, IBM Lotus, iWork, etc.;
multimedia applications, e.g., Winamp, Windows Media Player, iTunes, Adobe Flash Player, etc.;
development platforms, e.g., Adobe AIR, Java, .Net, etc., and,
browsers, e.g., Mozilla Firefox, Safari, Opera, Microsoft Internet Exporer, Chrome; and other browsers.

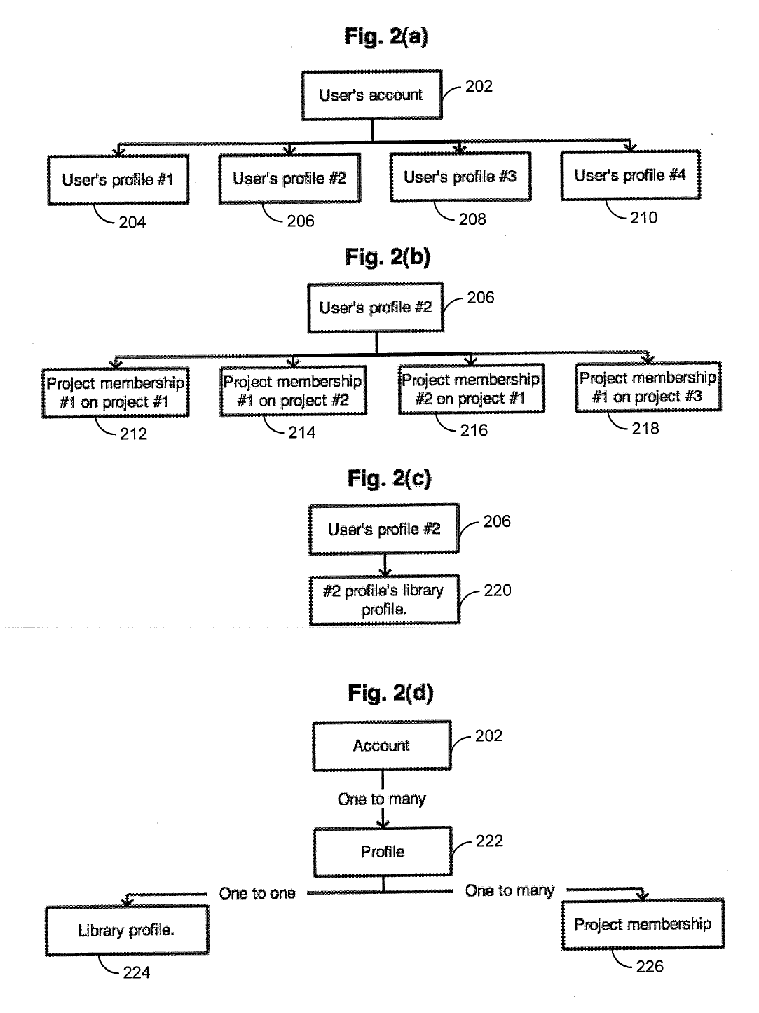

FIG. 2(a) depicts an exemplary user account data structure. In an embodiment of the invention, a user account 202 may have multiple user profiles 204, 206, 208, 210. Thus, a user may participate in different forums, groups or the like and have a profile for each. The number of profiles is not limited to those depicted in FIG. 2(a). If a user wants to connect to or collaborate with another user, it is preferably done through use of profiles. This has the effect of causing all relationships to be between profiles, not between user accounts.

User collaboration may be achieved through project membership. As depicted in FIG. 2(b), a user profile 206 may support membership in multiple projects 212, 214, 216, 218. In an embodiment of the invention, the number of project memberships that may be supported is unlimited, and a project membership is created when a user accepts a project invitation through one of their user profiles. This ties the project membership to that particular user profile. A user may also collaborate on a project with multiple project memberships owned by the same or different user profiles.

FIG. 2(c) depicts an exemplary user profile 206 and an associated library profile 220. In an embodiment of the invention, a user saves a project to a project model in a project library, creating a library profile 220, which is then associated with the user profile 206. A user may choose to use a name other than that stored in their user profile 206 to publish a project model. This may be facilitated using a library profile 220.

FIG. 2(d) depicts a summary of the relationships between user accounts 202, user profiles 222, library profiles 224 and project memberships 226 in an embodiment of the invention. Thus, as depicted, the a user account 202 has a one-to-many association with user profiles 222, which, in turn, have a on-to-one relationship with library profiles 224 and a one-to-many relationship with project memberships 226.

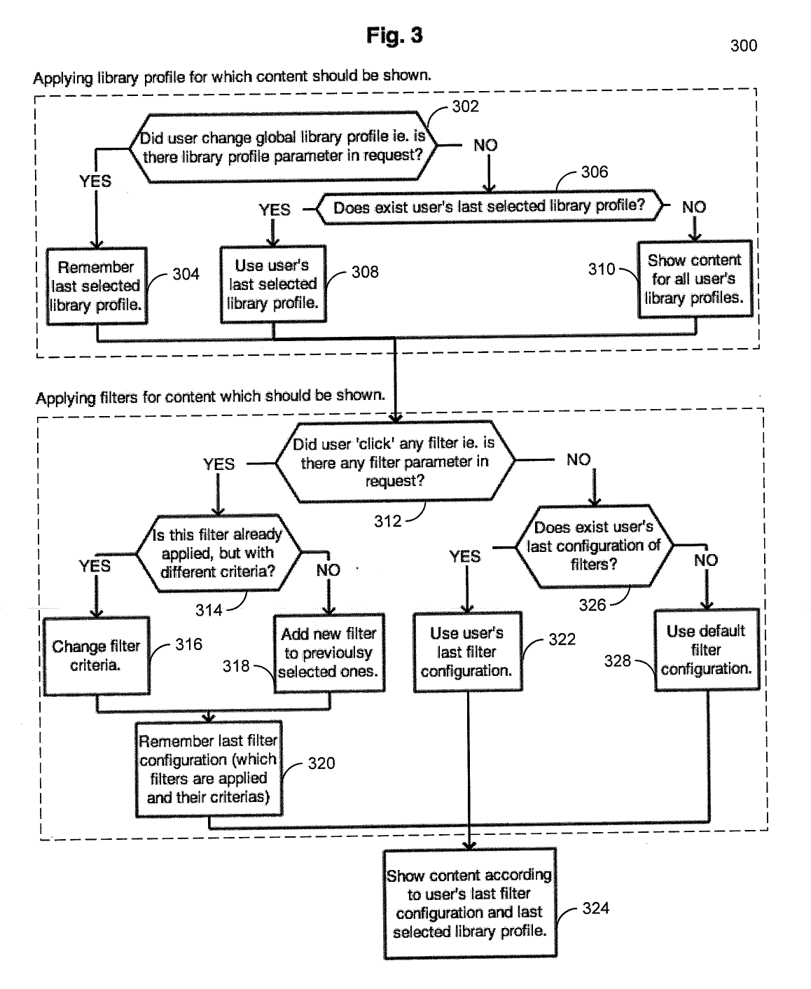

FIG. 3 depicts exemplary processes 300 for the filtering of content and for applying content filters, which is preferably invoked whenever filtering of content is needed. In an embodiment of the invention, if a user changes a global library profile, i.e., if a library profile parameter is in request 302, the prior selected library profile is selected 304. Otherwise, if the user's last library profile exists 306 it is selected 308. If not, content is shown for all the user's library profiles 310. Examples of filter types include, but are not limited to: activity, like, suggestions, date & time, project modeler, name, topic, comments, number of projects created, popularity.

Next, if the user selected a filter, i.e., is there a filter parameter in request 312? If so, when the filter is already applied but with different criteria 314, the filter criteria is changed 316. When the filter is not already applied with different criteria 314, a new filter is added to the previously selected ones 318. In either case, the last filter configuration including which filters are applied and their criteria is remembered 320, and the content is displayed according to the user's last filter configuration and last selected library profile 324.

If there is no filter parameter in the request 312, when there is a pre-existing user's last configuration of filters 326, the user's last filter configuration is used 322. When there is no pre-existing user's last configuration of filters 326, a user default filter configuration is used 328. In either case, the content is displayed according to the user's last filter configuration and last selected library profile 324.

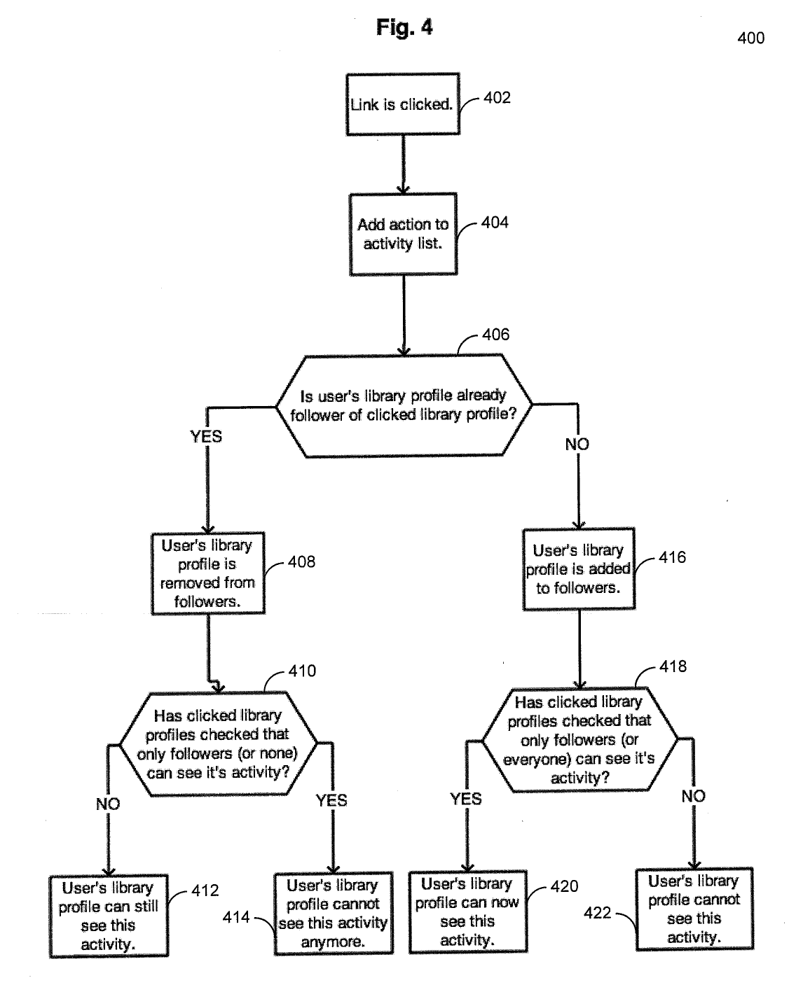

FIG. 4 depicts an exemplary process 400 followed when a user through their library profile selects a link to follow or unfollow some other library profile. In an embodiment of the invention, the user selects a link to another library profile 402. This action is then added to the activity list 404. If the user's library profile is already a follower of the selected library profile 406, the user's selection is interpreted as a command to remove the user's library profile from the selected library profile's list of followers 408. If the selected library profile only allows followers to see it's activity 410, then the user's library profile can no longer view this activity 414. Otherwise, the user's library profile can still view this activity 412.

If the user's library profile is not already a follower of the selected library profile 406, the user's selection is interpreted as a command to add the user's library profile to the selected library profile's list of followers 416. If the selected library profile only allows followers to see it's activity 410, then the user's library profile can view this activity 420. Otherwise, the user's library profile cannot view this activity 422.

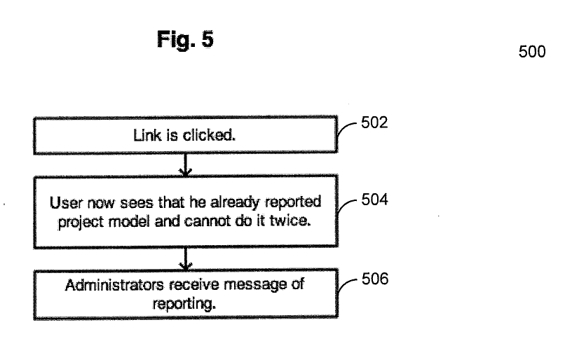

FIG. 5 depicts exemplary actions taken when a user selects a link for reporting a project model 500. In an embodiment of the invention, when a user selects 502 a link for reporting a project model, the administrators receive a message of the reporting 506. If the project model is already reported by the user, the same user receives a message that it is already reported and cannot be reported again 504.

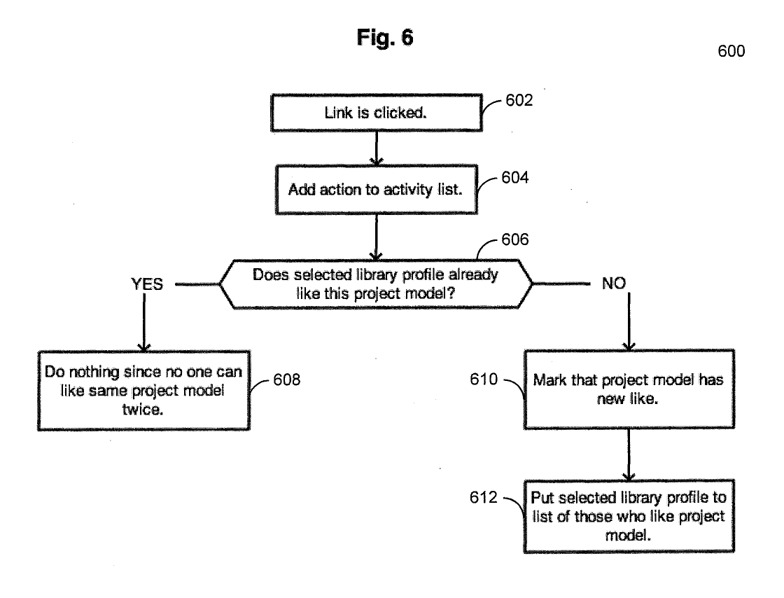

Whenever a user through the user's selected library profile selects a link to a project model the user “likes”, the exemplary process 600 depicted in FIG. 6 occurs. For a user to “like” a project model as used herein is a particular term of art conveying the user's desire to incorporate the particular project model into their own design(s). Thus, in an embodiment of the invention, when the user selects 602 a project model they like, this action is added to the activity list 604. If the selected library profile has already selected to like this project model 606, no action is taken 608. Otherwise, the project model is marked to include the new like 610, and the selected library profile is added to the list of those who like the project model 612.

A user can also “dislike” a project model. This has no effect on user's library, but can effect position of project model in list of all other project models.

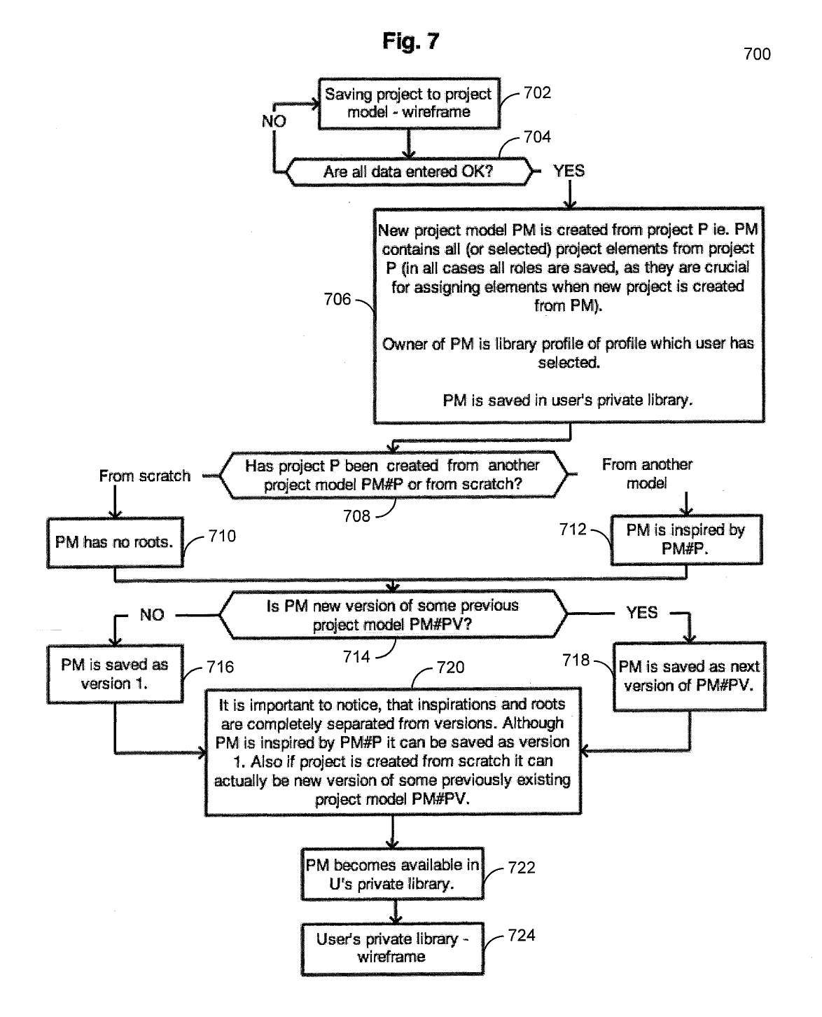

FIG. 7 depicts exemplary process flow 700 when saving a project to a project model. In an embodiment of the invention, the user enters project data and selects saving the project to a project model 702, and the data entered by the user is checked 704. If data is missing, the user returns to the data entry and saving step 702. Otherwise, a new project model is created containing all the project elements 706. Preferably, All roles are saved, and the owner of the project model is the library profile which the user has selected, with the project model being saved in the user's private library.

If the project model has been created from scratch 708, the project model has no roots 710, otherwise, the project model is considered “inspired” by the project model it was created from 712.

If the project model is a new version of a previous project model 714, it is saved as the next numbered version 718. Otherwise, the project model is saved 716 as version 1. In either case, it is important to note that in an embodiment of the invention, inspirations and roots are completely separate from versions 720. Although a project model may be inspired by another project model, it may still be saved as version 1 Likewise, if a project model is created from scratch, it can actually be a new version of some previously existing project model. Next, the project model becomes available in the user's private library 722, and the user may be presented 724 with the private library user interface.

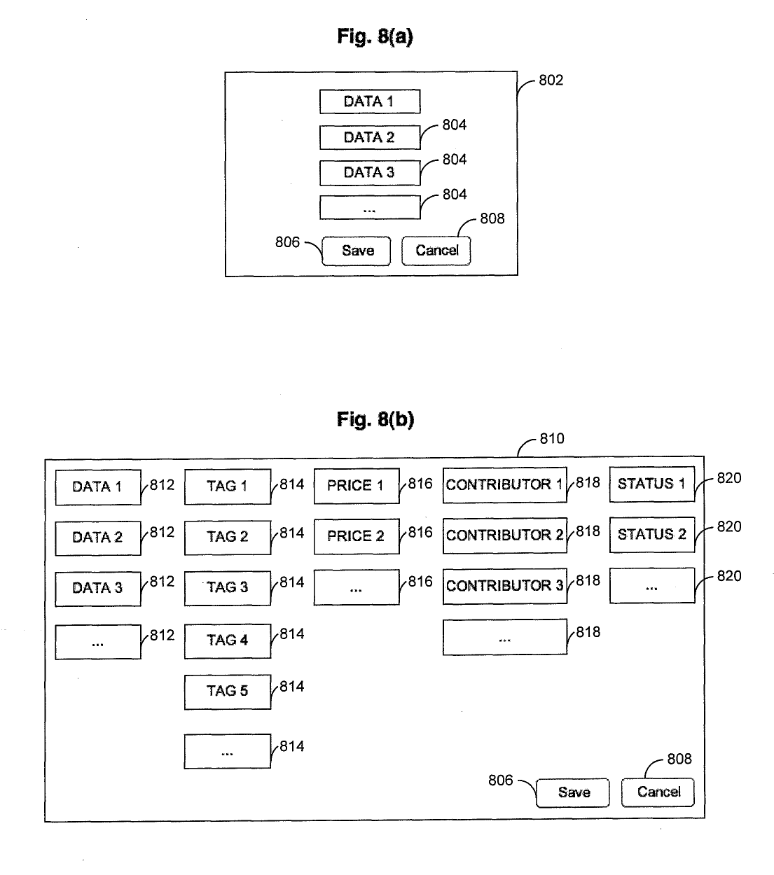

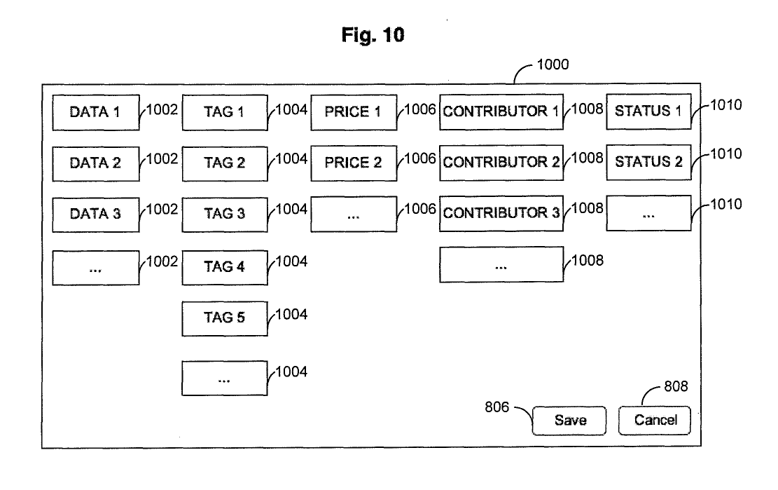

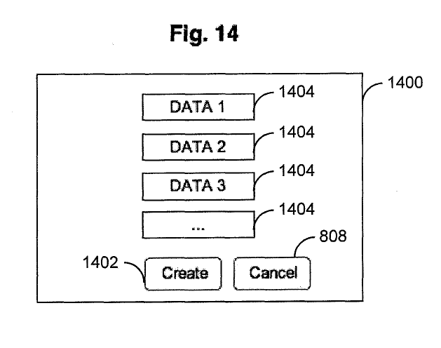

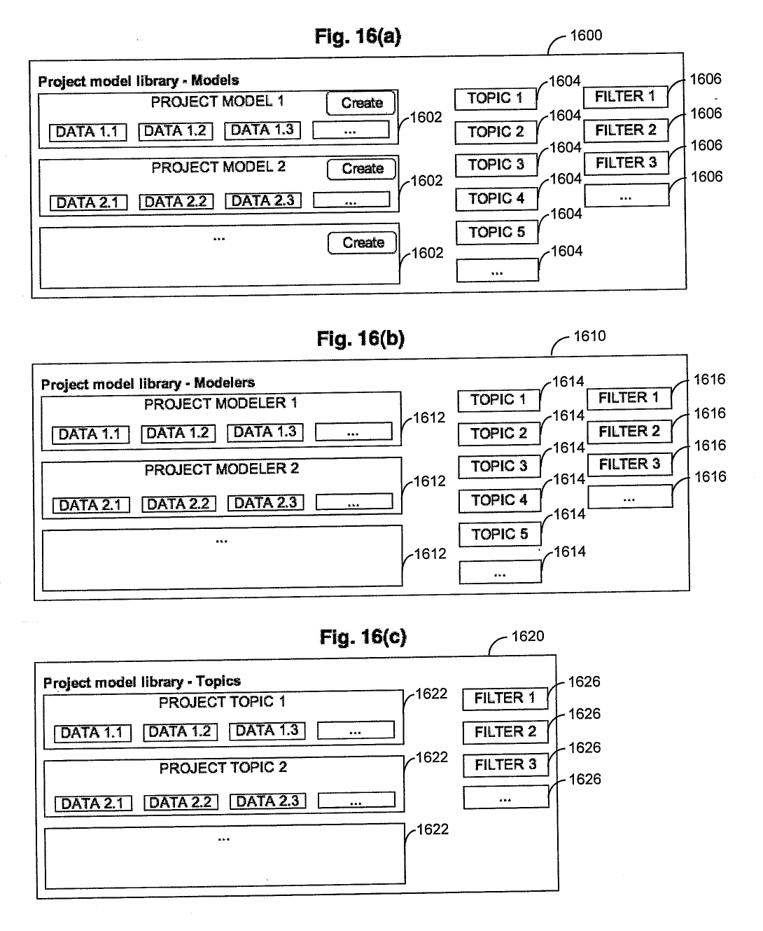

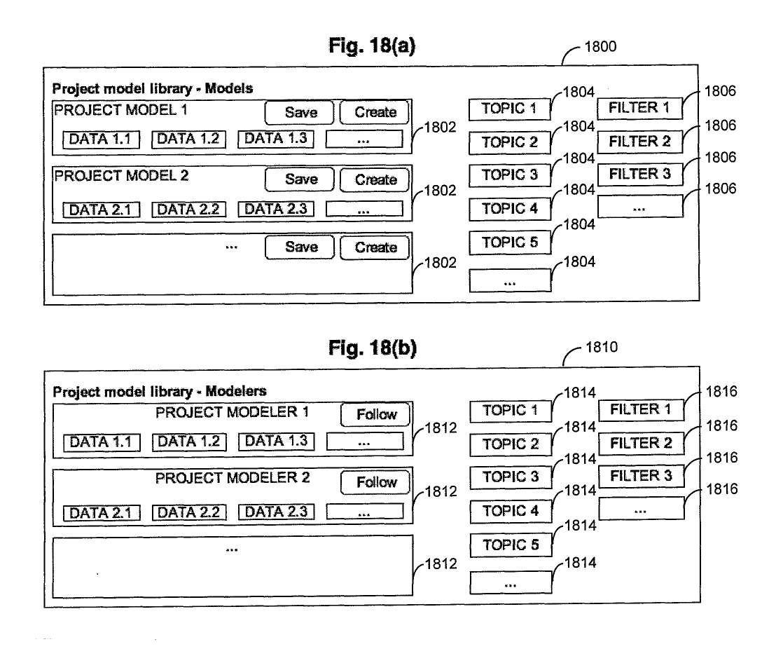

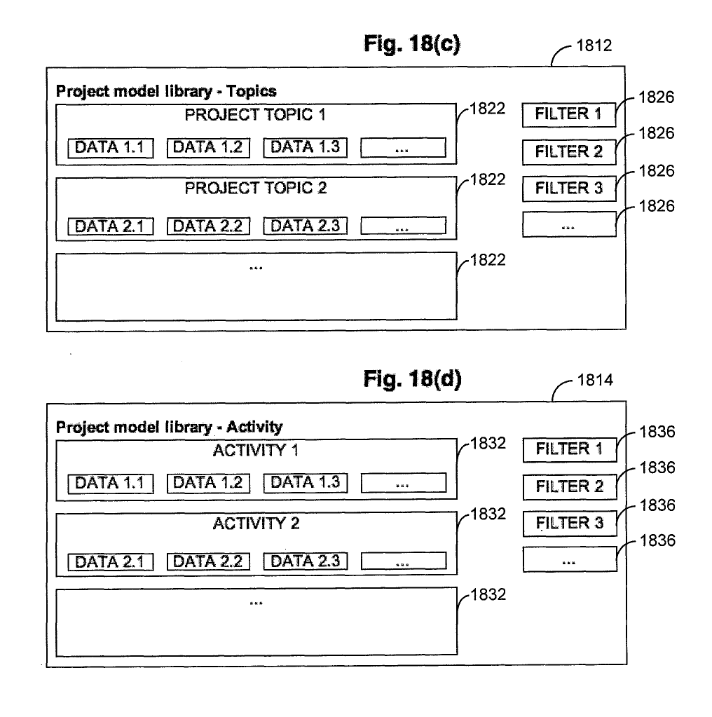

FIGS. 8(a), 8(b), 10, 14, 16(a), 16(b), 16(c), 18(a), 18(b), 18(c) and 18(d) depict exemplary user interface screens in an embodiment of the invention. In many instances these user interface screens have save 806, cancel 808 and/or create 1402 buttons, which, depending on the particular screen and the context, perform the functions normally associated with such user interface facilities.

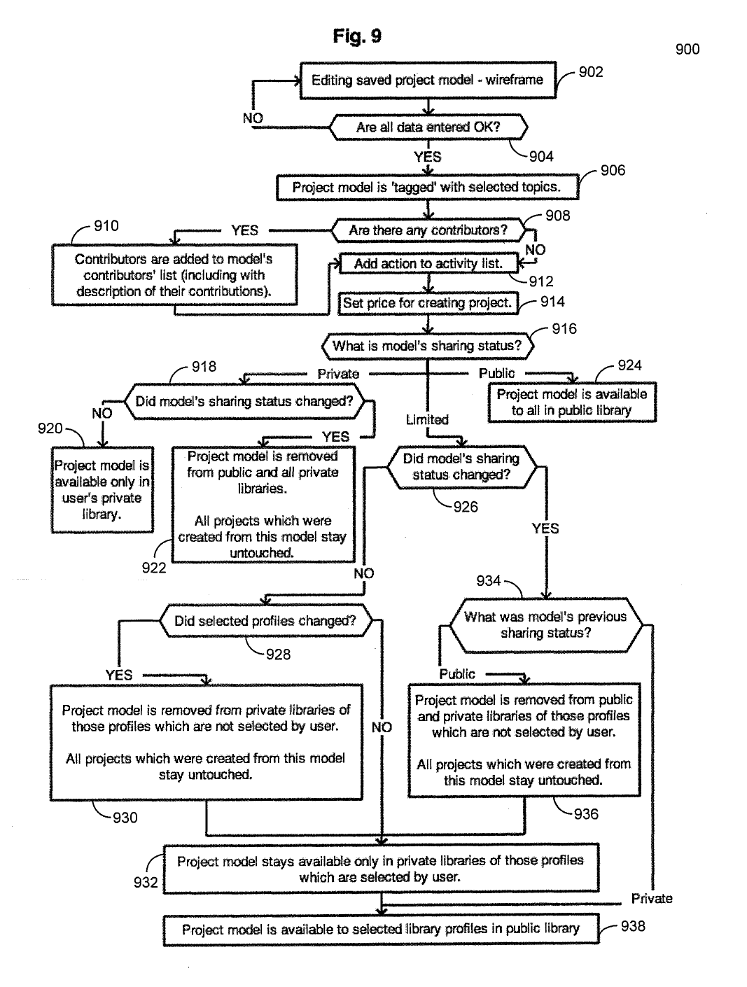

FIG. 9 depicts exemplary processing 900 when the user selects to edit a saved project model. In an embodiment of the invention, the user inputs project model data and selects 902 to edit a project model. If the entered data is not correct 904, the user is again able to edit the project model data 902. Otherwise, the project model is tagged with the selected topics 906.

Next, if there are any other contributors to the project model 908, the contributors are added to the model's contributors' list along with a description of their contributions 910. An add action is then added to the activity list 912 and if project model is payable a price is set 914 for creating the project.

The project model's sharing status is then determined 916. When the sharing status is “public”, the project model is available to all in the public library 924. When the project model is “private”, if the project model's sharing status has not changed it is available only in the user's private library 920. If the project model's sharing status has changed to private, the project model is removed from the public and all private libraries, although all projects which were created from this model remain untouched 922.

When the sharing status is “limited”, if 926 the project model's sharing status has not changed, if the selected profiles have changed 928, the project model is removed from the private libraries of those profiles which are not selected by the user 930, all projects which were created from this project model remain untouched, and the project model stays available only in private libraries of those profiles which are selected by the user 932. If the project model's status has changed, if the previous sharing status 934 was public, the project model is removed from the private libraries of those profiles which are not selected by the user 936, and all projects which were created from this project model remain untouched. In either case, the project model is available to any selected library profiles in the public library 938.

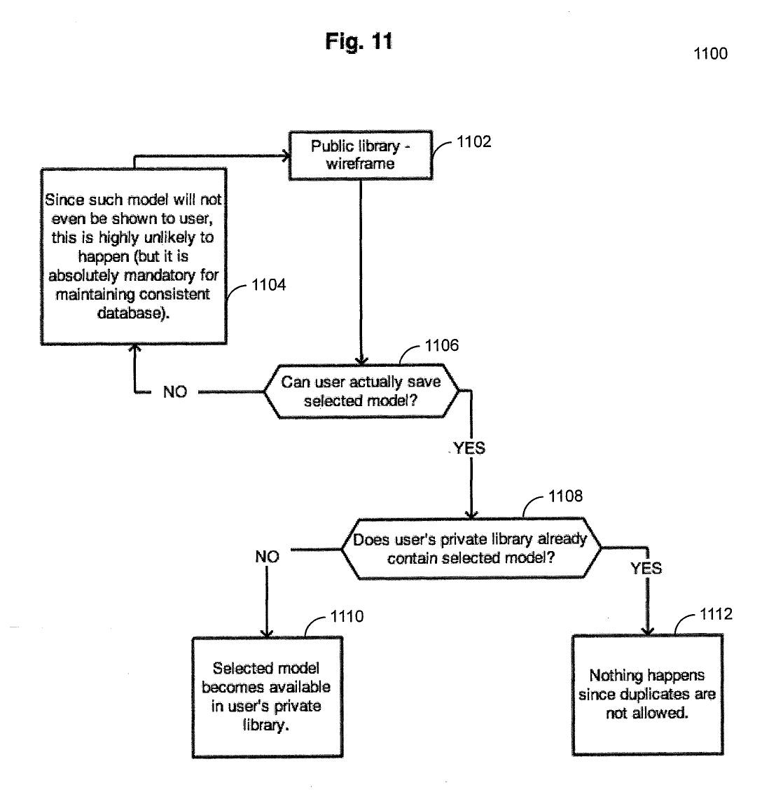

FIG. 11 depicts an exemplary process 1100 that occurs when a project model is saved from a public to a private library. In an embodiment of the invention, from the public library user interface 1102, the user selects a project model to save, and it is determined whether the user has sufficient rights to actually save the selected project model 1106. Although it is unlikely to occur that the user does not have these rights, this check is useful for maintaining a consistent database and preventing unauthorized actiones 1104. In an embodiment of the invention, a standard computer database may be used. Examples of usable databases include, but are not limited to: MySq1, Postgres, Oracle, db4o, MS-Access, MS-SQL, and the like.

If the user has sufficient rights, the user's private library is checked 1108 to determine if it already contains the selected project model. If it does, no further processing is needed 1112. Otherwise, the selected project model becomes available in the user's private library 1110.

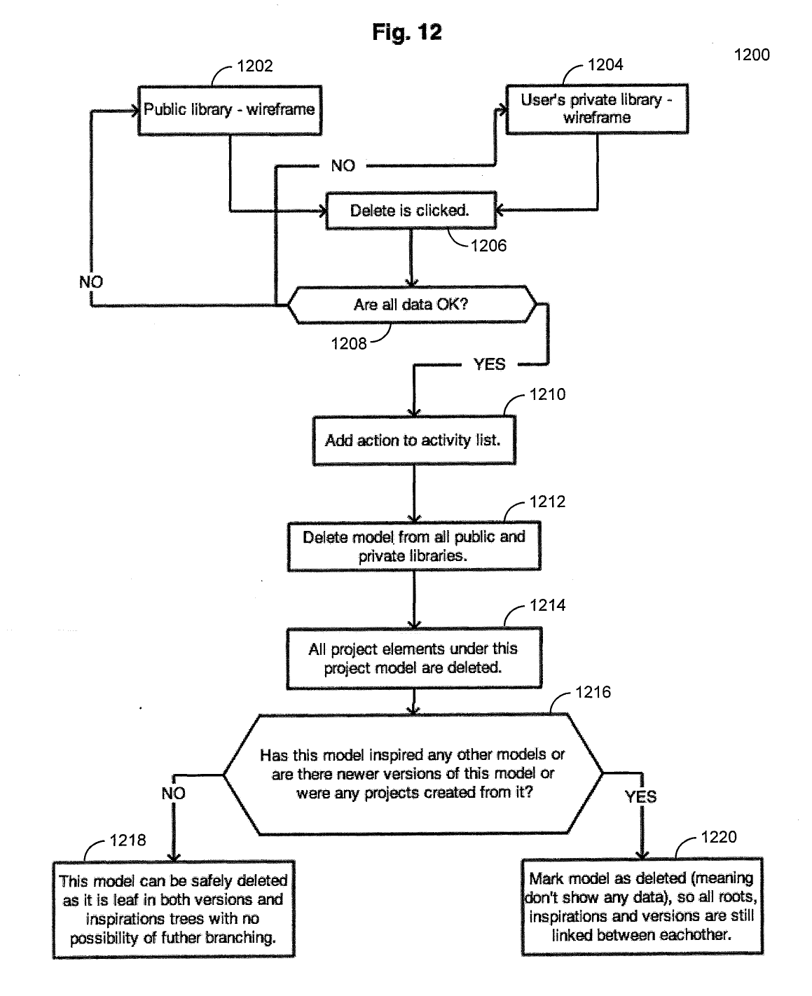

FIG. 12 depicts an exemplary process 1200 which occurs when a user selects to delete a project model from a project library. In an embodiment of the invention, the user selects to delete 1206 a project model from either a public project library user interface 1202 or a private project library user interface 1204. After the selection data is validated 1208, the delete action is added to the activity list 1210. Next, the project model is deleted from all public and private libraries 1212, and all project elements under this project model are deleted as well 1214.

If the deleted project model has inspired any other models, or if there are newer versions of this model or any projects created from this project model 1216, the project model is marked as deleted, thereby preserving all roots, inspirations, versions and links between each other 1220. Otherwise, the project model can be safely deleted 1218.

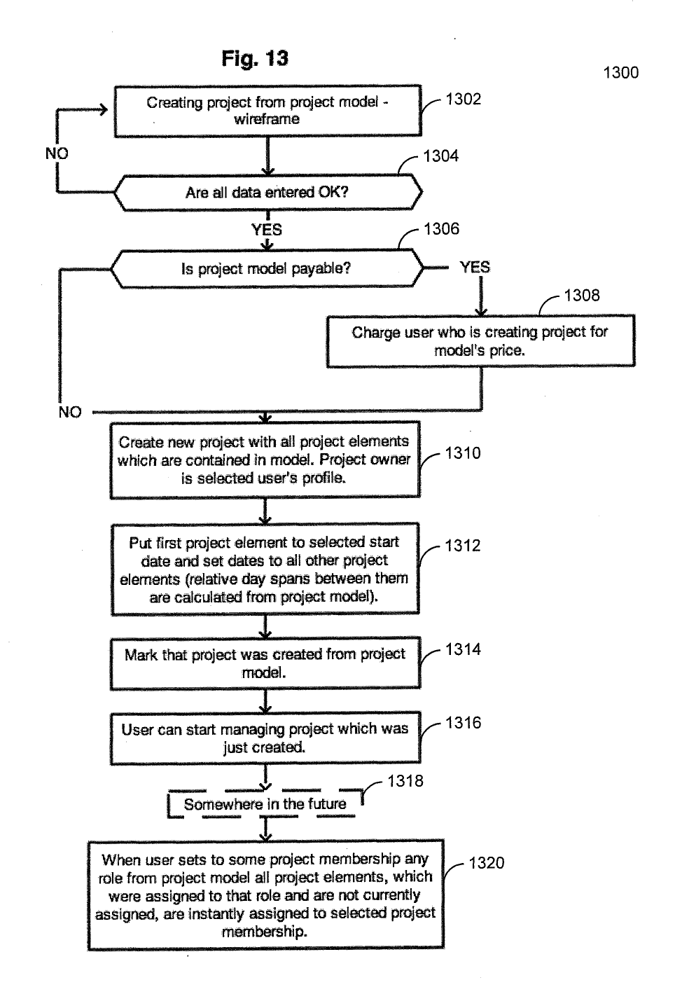

FIG. 13 depicts an exemplary process 1300 which occurs when the user selects to create a new project from an existing project model. In an embodiment of the invention, the user selects to create a project model from a project model creation user interface 1302 by entering and selecting relevant data. Once the data has been validated 1304, if the existing project model is “payable” 1306—i.e., if the existing project model requires payment of a fee to use—the user is charged the amount of the existing project model's price 1308. In one embodiment of the invention, a share of the fee can be paid to the author of the project model.

Next, a new project model is created with all the project elements which are contained in the existing project model, and the project model's owner is selected to be the user's profile 1310. Project element dates are then set 1312, and the new project model is marked as created from the existing project model 1314. The user may then proceed with routine project model management 1316.

At a later time 1318, when the user sets to some project membership any role from the project model, all project elements which were assigned to that role and are unassigned at time of action are automatically assigned to the selected project membership 1320.

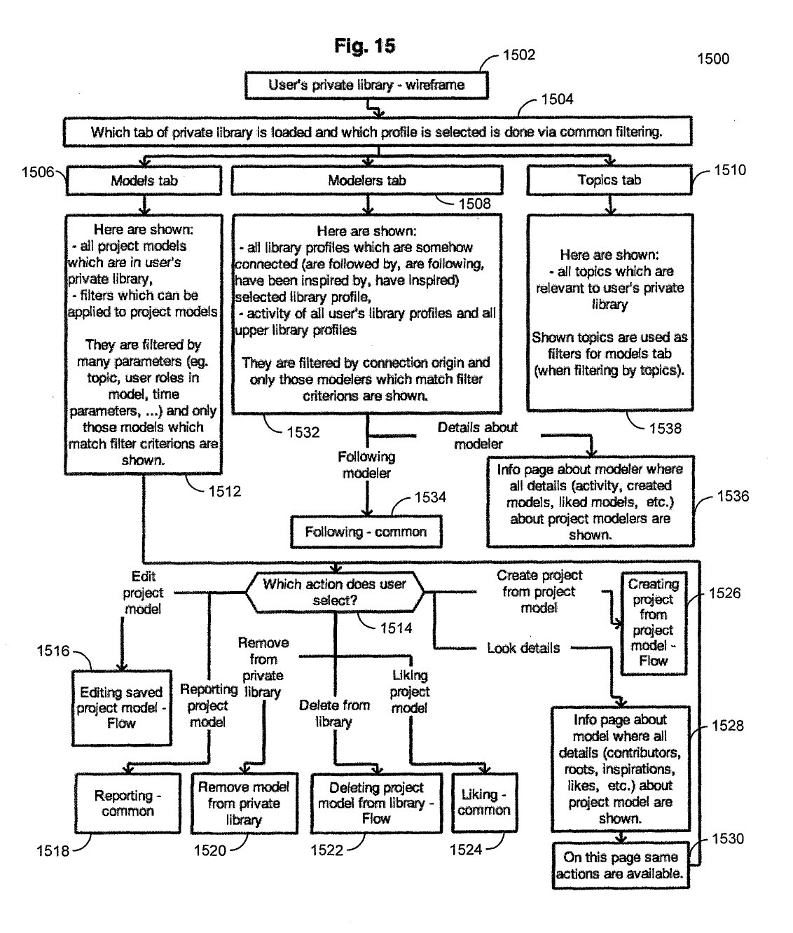

FIG. 15 depicts exemplary processing 1500 available for managing the user's private library. In an embodiment of the invention, the user is presented with a user interface 1502 for managing the user's private library. The user may select 1504 which tab of the private library is loaded via common filtering, which is further described in FIG. 3.

By selecting the “Models” tab 1506, all project models which are in the user's private library are shown, as well as the filters which can be applied to the project models 1512. The project models may be filtered by many parameters, such as but not limited to, topic, user roles in model, time parameters, etc. Only those models which match the selected filter criterion are shown. From this, the user may select 1514 any of several actions to apply to the selected project model, including editing 1516, reporting 1518, removing from private library 1520, deleting 1522, “liking” 1524, creating a new project from 1526, or bring up a page of additional information about the project 1528, which also includes the ability to select the other actions 1530.

By selecting the “Modelers” tab 1508, all library profiles which are somehow connected—e.g., are followed by, are following, have been inspired by, have inspired, or the like—the selected library profile are displayed 1532. the user may then select to follow the selected library profile 1534 or may select to see additional modeler details 1536.

By selecting the “Topics” tab 1510, all topics which are relevant to the user's private library are shown, and the shown topics may be used as filters for the models tab 1538.

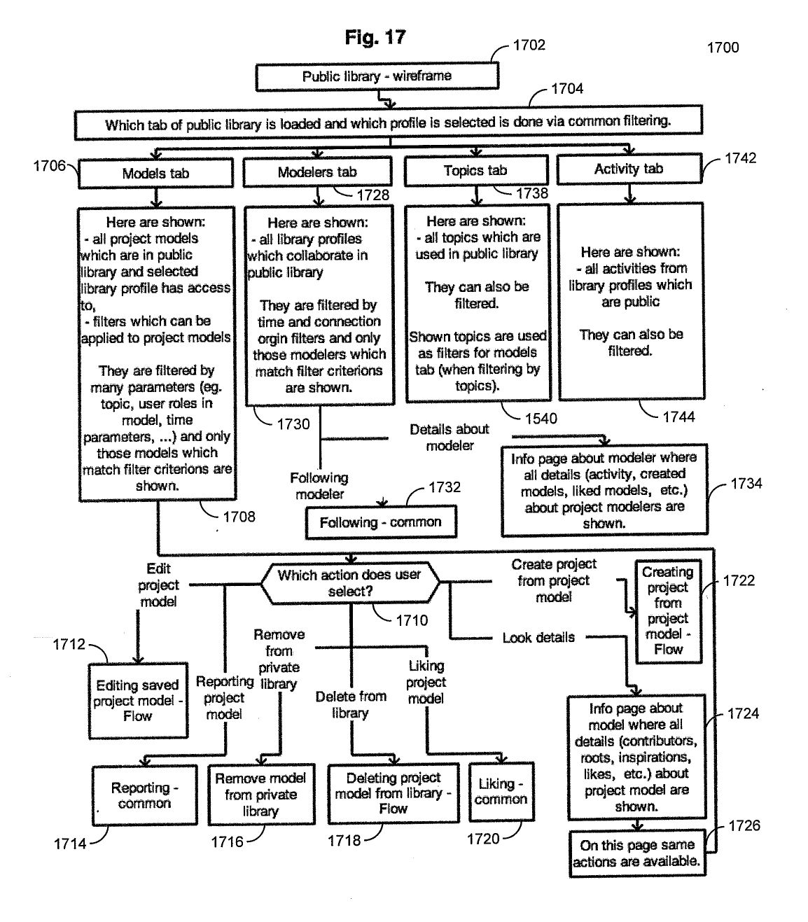

FIG. 17 depicts exemplary processing 1700 available for managing the public library. In an embodiment of the invention, the user is presented with a user interface 1702 for managing the public library. The user may select 1704 which tab of the private library is loaded via common filtering, which is further described in FIG. 3.

By selecting the “Models” tab 1706, all project models which are in the public library are shown, as well as the filters which can be applied to the project models 1708. The project models may be filtered by many parameters, such as but not limited to, topic, user roles in model, time parameters, etc. Only those models which match the selected filter criterion are shown. From this, the user may select 1710 any of several actions to apply to the selected project model, including editing 1712, reporting 1714, removing from private library 1716, deleting 1718, “liking” 1720, creating a new project from 1722, or bring up a page of additional information about the project 1724, which also includes the ability to select the other actions 1726.

By selecting the “Modelers” tab 1728, all library profiles which are somehow connected—e.g., are followed by, are following, have been inspired by, have inspired, or the like—the selected library profile are displayed 1730. the user may then select to follow the selected library profile 1732 or may select to see additional modeler details 1734.

By selecting the “Topics” tab 1736, all topics which are relevant to the public library are shown, and the shown topics may be used as filters for the models tab 1738.

By selecting the “Activity” tab 1740, all activities from public library profiles are shown 1742. These may also be filtered.

Having thus described the invention of the present application in detail and by reference to illustrative embodiments thereof, it will be apparent that modifications and variations are possible without departing from the scope of the invention defined in the appended claims.

What is claimed is:

1. A computerized system for management of one or more project models allowing a user to access the project models, the system comprising:
a computer interface operating on a user's computer device, the computer device further comprising a processor and associated computer memory, a display and one or more input device, the computer device in communication with the computer database, the processor and memory configured to provide the interface for the user to access the computer database;
the user having a user account and one or more user profiles, each user profile being associated with one or more project membership, and each user profile being further associated with a project model library profile, which is connected with a project model library;
the project model library comprising a computer database for storing the one or more project models, one or more project data files related to each project and information related to each project model;
wherein, the user is presented with a listing of the one or more project models and the information related to each project model; and
wherein, upon user selection of a project model, the one or more related project data files, and information related to the selected project model are provided to imported to the user's computer device.

2. The system according to claim 1, wherein the project model library is public, thereby allowing access to other users.

3. The system according to claim 2, whereby access to the project model library requires payment of a fee.

4. The system according to claim 3, wherein the a portion of the fee is provided to an author of the project model library.

5. The system according to claim 1, wherein the project model library is private, thereby allowing access to the owner only.

6. The system according to claim 1, wherein the project model library is limited/restricted, thereby restricting access to the user and the user's allowed project model library profiles of other users only.

7. The system according to claim 1, wherein the listing of one or more project models presented to the user is filtered according to one or more parameters.

8. The system according to claim 7, wherein the one or more parameters for filtering are selected from the list comprising: activity, like, suggestions, date/time, project modeler, name, topic, comments, number of projects created, popularity, money earned, time saved, pollution reduced.

9. A method for managing one or more project models, allowing a user to access the project models, the method comprising:
operating a computer interface on a user's computer device, the computer device further comprising a processor and associated computer memory, a display and one or more input device, the processor and memory configured to provide the interface for the user to access a project model library;
automatically associating the user with a user account and one or more user profiles, each user profile being associated with one or more project membership, and each user profile being further associated with an individual project model library;
presenting the user with a listing of the one or more project models and the information related to each project model; and
selecting by the user a project model, along with any related project data files, and information related to the selected project model are provided to imported to the user's computer device.

10. The method according to claim 9, wherein the project model library is public, thereby allowing access to other users.

11. The method according to claim 9, whereby access to the project model library requires payment of a fee.

12. The method according to claim 9, wherein the project model library is private, thereby allowing access to the owner only.

13. The method according to claim 9, wherein the project model library is limited/restricted, thereby restricting access to the user and the user's allowed project model library profiles of other users only.

14. The method according to claim 9, wherein the listing of one or more project models presented to the user is filtered according to one or more parameters.
